(19) United States
(12) Patent Application Publication
(10) Pub. No.: US 2010/0325924 A1
(43) Pub. Date: Dec. 30, 2010

(54) GIFT CARD PACKAGE

(76) Inventors: Mark V. Aletto, Moon Township, PA (US); Richard J. Mackey, Moon Township, PA (US)

Correspondence Address: MCNEES WALLACE & NURICK LLC, 100 PINE STREET, P.O. BOX 1166, HARRISBURG, PA, 17108-1166, US

(21) Appl. No.: 12/490,776

(22) Filed: Jun. 24, 2009

(51) Int. Cl. G09F 1/00; G09F 1/04

(52) U.S. Cl. 40/124.03; 40/124.06; 40/124.08

(57) ABSTRACT

A gift card package that allows an individual to present a greeting card and a gift to recipient at the same time. Also provided is a greeting card and gift that a recipient will want to collect.

### BACKGROUND OF THE INVENTION

The described invention relates in general to greeting cards and more specifically to a greeting card assembly and package. This invention is a useful item that allows an individual to present a greeting card and a collectable gift to recipient at the same time.

The greeting card industry is a multi-billion dollar a year industry. Consumers buy cards for a variety of reasons. Most often cards are bought to celebrate a person's birthday or another special occasion. Many of the cards available to consumers today offer options in expressing the consumer's feelings or thoughts. The cards that are available to consumers vary from traditional folded greeting cards, that have an outside front and back cover and an inside area for text or writing; multi-fold greeting cards, that have two or more folds and are folded in a manner to provide an outside front and back cover and an interior area; cards that provide three-dimensional “pop-up” shapes when opened; cards that provide an area to hold money or lottery tickets; cards that provide an area to hold and display candy; and even cards that play music or a message when a recipient of the card opens the card. Although a consumer may spend considerable time or just moments in selecting a card for a recipient, most recipients tend to dispose of their cards after looking at them or enjoying them only for a few days.

What is needed, therefore, is an improved greeting card for gift giving. In particular, the greeting card assembly and package should enable a consumer the ability to give a recipient a greeting card and collectable gift at the same time, in one simple package. Further, the invention provides the collectable keepsake item, which will not be disposed of in a few days after receipt.

### SUMMARY OF THE INVENTION

The following provides a summary of exemplary embodiments of the gift card package according to the present invention. This summary is not an extensive overview and is not intended to identify key or critical aspects or elements of the present invention or to delineate its scope.

A first exemplary embodiment of this invention provides a gift card assembly and package comprising a first leaf portion, a second leaf portion, and a third leaf portion; the first leaf portion connected to the second leaf portion by a first margin strip; the second leaf portion connected to the third leaf portion by a second margin strip; and the second leaf portion and third leaf portion opposingly symmetrical and foldable at the first and second margin strips and adjacent to the first leaf portion, and first, second, and third leaf portions define a hollow space when folded to accommodate one or more articles therebetween.

A second exemplary embodiment of this invention provides a guitar pick shaped greeting card assembly and gift holder comprising: a tripartite web of cardstock, wherein the tripartite web of cardstock is further comprised of: (i) a first leaf portion having a tapered tip, (ii) a second leaf portion, and (iii) a third leaf portion having a slot adapted to receive the tapered tip of the first leaf thereinto, the first leaf connects to the second leaf by a first margin strip and the second leaf connects to the third leaf by a second margin strip, the first leaf, the second leaf and the third leaf further comprises an interior side and an exterior side, and wherein the first margin strip and second margin strip are foldable, and such that when the tapered tip of the first leaf is inserted into the slot of the third leaf, the tripartite web forms a self-supporting three-dimensional greeting card and gift holder.

A third exemplary embodiment of this invention provides a three-dimensional greeting card and gift holder comprising: (a) first leaf portion having a tapered tip and generally configured in the profile of a guitar pick, (b) a second leaf portion having a truncated guitar pick profile, the second leaf foldable behind the first leaf, and attached to the first leaf by a first margin strip, and the second leaf further comprising a holder arranged to hold articles, and (c) a third leaf portion having a truncated guitar pick profile, the third leaf opposingly symmetrical to the second leaf, the third leaf attached to the second leaf by a second margin strip, an slot disposed in the third leaf to receive the tapered tip, and a plurality of slits disposed in the third leaf to hold articles, wherein the tapered tip of the first leaf may be inserted into the slot of the third leaf to define a three-dimensional greeting card and gift holder.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is top view of the outline of exterior side of the gift card package.

FIG. 2 is a top view of the outline of internal side of the gift card package.

FIG. 3 is a perspective view of the three-dimensional gift card package.

FIG. 4 is a top view of the gift card package showing how second and third leaf portions are mirror images, and how they are foldable behind the first leaf portion.

FIG. 5 is a side view of gift card package showing how the margin strips create a hollow area for holding gift items.

FIG. 6 is a top view of the exterior side of the gift card package with text, graphics, images, and collectable gift items.

FIG. 7 is a top view of the interior side of the gift card package with text, graphics, images, certificates of authenticity, and collectable gift items

### DETAILED DESCRIPTION OF THE INVENTION

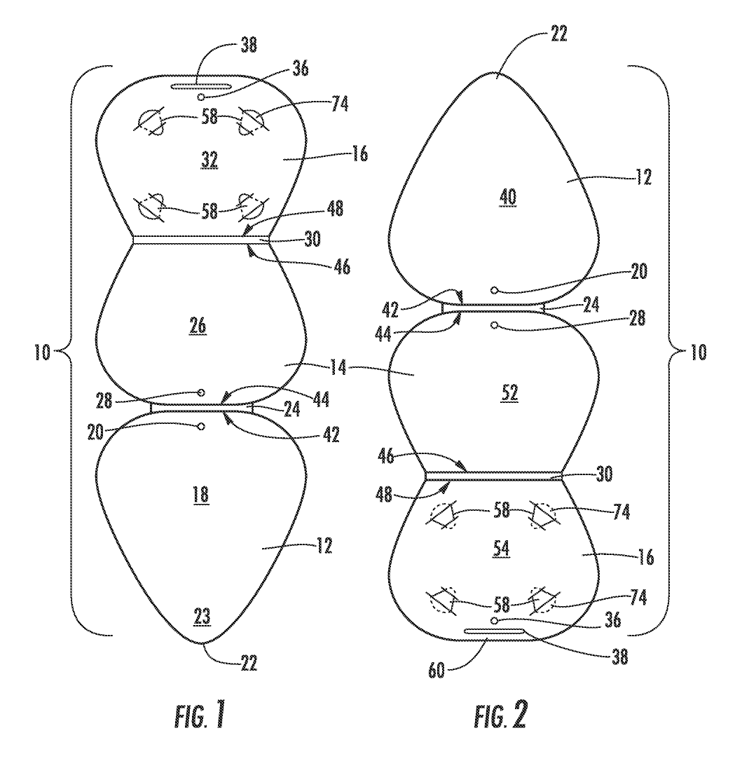

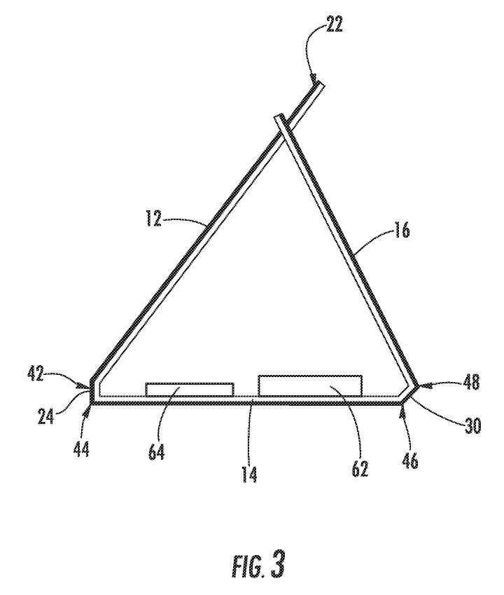

FIG. 1 illustrates the exterior side of unassembled guitar pick shaped greeting card assembly and package 10. FIG. 2 illustrates the interior side of unassembled guitar pick shaped (including but not limited to, teardrop or triangular shapes) greeting card assembly and package 10. Greeting card assembly and package 10 may be any material which allows the desired three-dimensional structure to be formed from a foldable sheet. For example, the material for greeting card assembly and package 10 may be paper, cardstock, coverstock, cardboard, plastic, or similar flat, foldable sheet material. Preferably, greeting card assembly and package 10 is manufactured from cardstock.

Greeting card assembly and package 10 includes: a first leaf portion 12, a second leaf portion 14, and a third leaf portion 16. First leaf portion 12 is connected to second leaf portion 14 via a first margin strip 24. Second leaf portion 14 is connected to third leaf portion 16 via a second margin strip 30. Third leaf portion 16 has a slot 38 for receiving a tip tapered 22 of leaf portion 12. First leaf portion 12 has an aperture 20, second leaf portion 14 has an aperture 28, and third leaf portion 16 has an aperture 36. The apertures 20, 28, and 36 allow gift card assembly and package 10 to be hung at a store for sale or to be displayed by a recipient on a string or chain. Apertures 20, 28, and 36 are substantially aligned when leaf portions 12, 14, and 16 are folded or over-lapped, so that a hanger (not shown) may be used for display purposes.

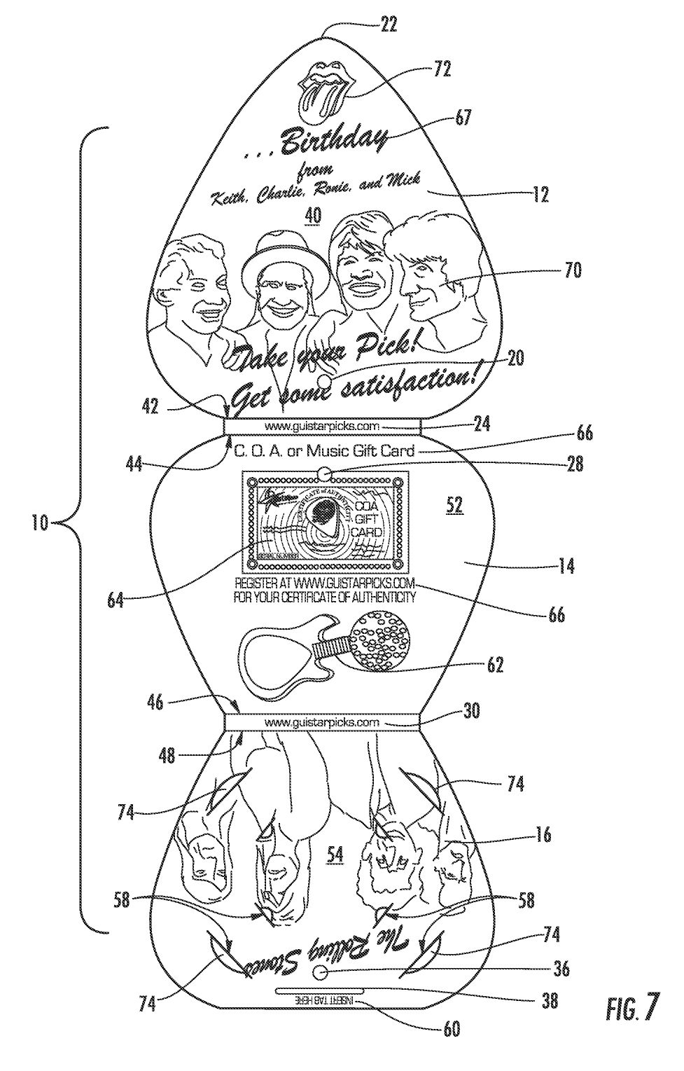

First leaf portion 12 has an exterior side 18, second leaf portion 14 has an exterior side 26, and third leaf portion 16 has an exterior side 32. Exterior sides 18, 26, and 32 of the leaf portions 12, 14, and 16 may respectively include text 66, greetings 67, graphics 68, pictures 70, images 72, and the like, see FIG. 6. Text 66 can be any type of writing. Greetings 67 can be any type of normal greeting card text such as, “Happy Birthday,” etc. Graphics 68, pictures 70, and images 72 on exterior sides 18, 26, and 32 of leaf portions 12, 14, and 16 respectively, can be part of a theme for the greeting card assembly and gift package 10. For example, the theme may feature or highlight a musical artist or band. Graphics 68, pictures 70, images 72, and the like will correspond to the featured musical artist or band. Graphics 68, pictures 70, and images 72 can be associated with a specific tour of the featured musical artist or group and may include artwork from a specific album from the featured musical artist or band.

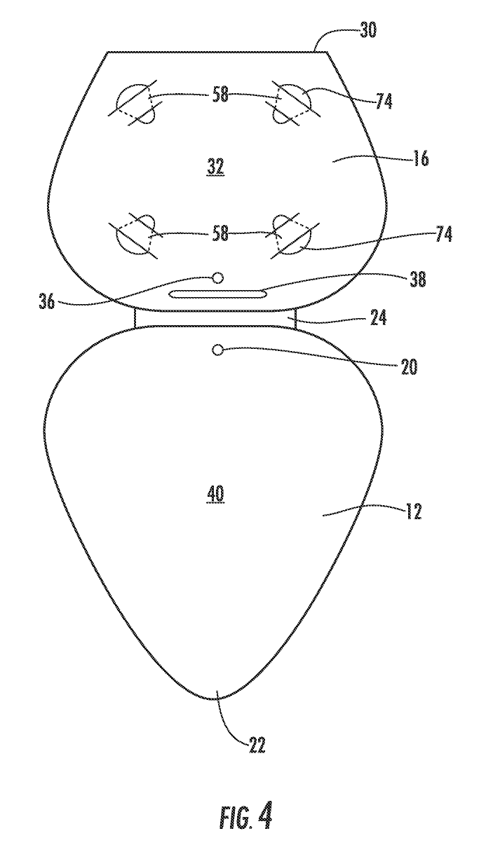

Exterior side 18 of first leaf portion 12 has a tip 22, shaped like the strumming edge of a guitar pick. Tip 22 is received by slot 38 to form a three-dimensional gift card assembly and package, as shown in FIG. 3. Tip 22 may include directions 23 for opening gift card assembly and package 10. To allow tip 22 to insert into slot 38, first margin strip 24 and second margin strip 30 are foldable in four places. A first fold line 42 is foldable along the area adjoining first leaf portion 12 and first margin strip 24. A second fold line 44 is foldable along the area adjoining first margin strip 24 and second leaf portion 14. A third fold line 46 is foldable along the area adjoining second leaf portion 14 and second margin strip 30. A fourth fold line 48 is foldable along the area adjoining second margin strip 30 and third leaf portion 16. Once each of the fold lines 42, 44, 46, and 48 have been made, first margin strip 24 and second margin 30 act like hinges to allow first leaf portion 12, second leaf portion 14, and third leaf portion 16 to remain rigid while allowing the tip 22 to insert into the slot 38. Margin strips 24 and 30 provide depth or volume when folded to define a space between 12, 14, and 16 for gifts.

Exterior side 32 of third leaf 16 contains slits 58 to hold items, such as guitar picks 74 from the featured musical artist or band. Slits 58 go through to the interior side 54 of third leaf 16 to form strips for retaining picks 74 in position. Guitar picks 74 can be personalized for the featured musical artist or band. Guitar picks 74 can optionally be finger-printed or signed by the featured musical artist or band members.

As shown in FIG. 2, first leaf portion 12 has an interior side 40. Second leaf portion 14 has an interior side 52. Third leaf portion 16 has an interior side 54. Interior sides 40, 52, and 54 of the leaf portions 12, 14, and 16, respectively are adapted to receive text 66, greetings 67, graphics 68, pictures 70, images 72, and the like, see FIG. 7. Text 66 can be any type of writing. Greetings 67 can be any type of normal greeting card text, such as “Happy Birthday,” etc. Graphics 68, pictures 70, and images 72 on exterior sides 18, 26, and 32 of leaf portions 12, 14 and 16 respectively, can be part of a theme for the greeting card assembly and gift package 10. For example, the theme may feature or highlight a musical artist or band. Graphics 68, pictures 70, images 72, and the like will correspond to the featured musical artist or band. Graphics 68, pictures 70, and images 72 can be associated with a specific tour of the featured musical artist or group and may include artwork from a specific album from the featured musical artist or band.

Interior side 52 is adapted to hold a collectable gift item or items. Examples of a collectable gift items include guitar pick holder necklaces, or pieces of the featured musical artist or band's clothing worn on tour. An example of a gift item is a prepaid gift card for purchasing music from retailers. Another example could include food items such as candy. Interior side 52 of second leaf portion 14 may include a certificate of authenticity (COA) for the collectable gift item used by the featured musical artist or band. Alternately, interior side 52 may contain an electronically readable/writable storage device that the recipient can use to store songs from the band or other music. In another embodiment, the storage device could also be pre-loaded with music from the featured musical artist or band from a specific tour or songs generally from the featured musical artist or band. In still another embodiment, interior side 52 may also contain a musical chip that plays a song from the featured musical artist or band when the greeting card assembly and package 10 is opened.

Interior side 54 of third leaf portion 16 contains slits 58 to hold articles, such as guitar picks 74. Guitar picks may include finger-prints or other indications associated with the featured musical artist or band. Interior side 54 has space for autographs or signatures 76 by the featured musical artist or band. Interior side 54 may include written instructions 60 on how to assemble the three-dimensional greeting card assembly and package 10.

FIG. 3 is a side view of assembled greeting card assembly and package 10, showing the self-supporting three-dimensional structure of the assembled greeting card assembly and package 10.

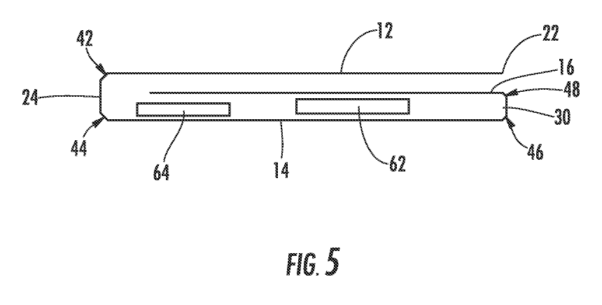

FIG. 4 is a top view of greeting card assembly and package 10 demonstrating how second leaf portion 14 (not shown) and third leaf portion 16 are mirror images. This figure further demonstrates that second leaf portion 14 and third leaf portion 16 are foldable behind first leaf portion 12, once first margin strip 24 is hingedly moved.

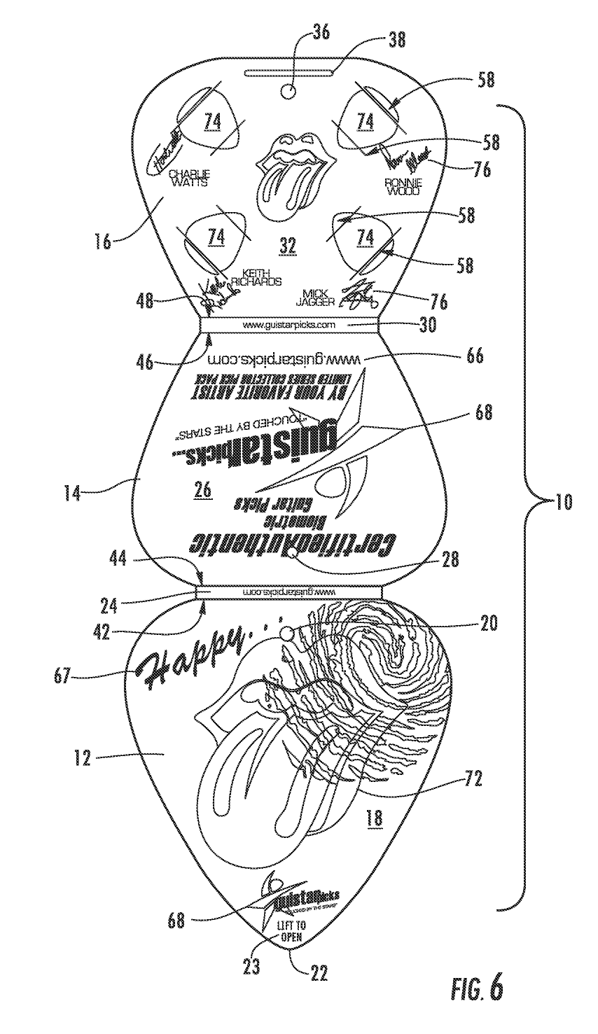

FIG. 5 is a side view of greeting card assembly and package 10, showing how margin strips 24 and 30 provide depth or volume when folded to define a space between 12, 14, and 16 for gifts.

While the present invention has been illustrated by the description of exemplary embodiments thereof, and while the embodiments have been described in certain detail, it is not the intention of the Applicants to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A gift card package comprising a first leaf portion, a second leaf portion, and a third leaf portion; the first leaf portion connected to the second leaf portion by a first margin strip; the second leaf portion connected to the third leaf portion by a second margin strip; and the second leaf portion and third leaf portion opposingly symmetrical and foldable at the first and second margin strips and adjacent to the first leaf portion, and first, second, and third leaf portions define a hollow space when folded to accommodate one or more articles therebetween.

2. The gift card package of claim 1, wherein each of the leaf portions, first, second and third, have an interior side and an exterior side, and at least one of the interior side and exterior side of each of the first, second, and third leaf portions contains one or more of text, messages, graphics, pictures, images, and the like.

3. The gift card package of claim 3, wherein one or more articles comprises a collectable gift item.

4. The gift card package of claim 4, wherein the third leaf portion further comprises at least one slit for receiving collectable items.

5. The gift card package of claim 4, wherein the collectable item is a guitar pick.

6. A guitar pick shaped greeting card assembly and gift holder comprising:
a tripartite web of cardstock, wherein the tripartite web of cardstock is further comprised of:
a) a first leaf portion having a tapered tip;
b) a second leaf portion; and
c) a third leaf portion having a slot adapted to receive the tapered tip of the first leaf thereinto;
the first leaf connects to the second leaf by a first margin strip and the second leaf connects to the third leaf by a second margin strip,
the first leaf, the second leaf, and the third leaf further comprises an interior side and an exterior side, and wherein the first margin strip and second margin strip are foldable, and such that when the tapered tip of the first leaf is inserted into the slot of the third leaf, the tripartite web forms a self-supporting three-dimensional greeting card and gift holder.

7. The greeting card assembly and gift holder of claim 6, wherein the interior side and exterior side, of each of the first, second, and third leaves, are adapted to receive and display one or more of text, messages, graphics, pictures, images, and the like.

8. The greeting card assembly and gift holder of claim 7, wherein the interior side of the second leaf is adapted to receive and hold one or more of gift articles, novelty items, or a certificate of authenticity.

9. The greeting card assembly and gift holder of claim 8, wherein the assembly further comprises a music chip to play a song when the card assembly is opened.

10. The greeting card assembly and gift holder of claim 9, wherein the assembly further comprises a musical storage device.

11. The greeting card assembly and gift holder of claim 10, wherein the third leaf is comprised of one or more of a series of slots for holding guitar picks from a featured musical band or artist, and an area for the signatures of the featured musical band or artist.

12. The greeting card assembly and gift holder of claim 11, wherein each leaf of the assembly is further comprised of an aperture disposed therein to hang the greeting card assembly at a store or to hang the greeting card assembly for display.

13. A three-dimensional greeting card and gift holder comprising:
a) first leaf portion having a tapered tip and generally configured in the profile of a guitar pick;
b) a second leaf portion having a truncated guitar pick profile, the second leaf foldable behind the first leaf, and attached to the first leaf by a first margin strip, and the second leaf further comprising a holder arranged to hold articles; and
c) a third leaf portion having a truncated guitar pick profile, the third leaf opposingly symmetrical to the second leaf, the third leaf attached to the second leaf by a second margin strip, a slot disposed in the third leaf to receive the tapered tip, and a plurality of slits disposed in the third leaf to hold articles, wherein the tapered tip of the first leaf may be inserted into the slot of the third leaf to define a three-dimensional greeting card and gift holder.

14. The three-dimensional greeting card and gift holder of claim 13, wherein each of the leaf portions, first, second and third, have an interior side and an exterior side.

15. The gift card package of claim 14, wherein both the interior side and exterior side of each of the first, second, and third leaf portions are adapted to receive and display one or more of text, messages, graphics, pictures, images, and the like.

16. The gift card package of claim 15, wherein the interior side of the second leaf portion is adapted to receive and hold one or more of gift articles, novelty items, or a certificate of authenticity.

17. The three-dimensional greeting card and gift holder of claim 16, wherein the card is themed on a featured musical artist or band.

18. The three-dimensional greeting card and gift holder of claim 17, wherein the card further comprises a music chip to play a song from the featured musical artist or band when the card is opened.

19. The three-dimensional greeting card and gift holder of claim 18, wherein the card further comprises a musical storage device, wherein the musical storage device is empty or contains pre-recorded music from the featured musical artist or band.

20. The three-dimensional greeting card and gift holder of claim 19, wherein the plurality of slits of the third leaf are filled with guitar picks from the featured musical artist or band.
